(19) United States
(12) Patent Application Publication
(10) Pub. No.: US 2026/0148480 A1
(43) Pub. Date: May 28, 2026

(54) IMAGE PROCESSING SYSTEM, IMAGE PROCESSING METHOD, AND STORAGE MEDIUM

(71) Applicant: CANON KABUSHIKI KAISHA, Tokyo (JP)

(72) Inventor: TAKU OGASAWARA, Tokyo (JP)

(21) Appl. No.: 19/375,000

(22) Filed: Oct. 30, 2025

(30) Foreign Application Priority Data
Nov. 26, 2024 (JP) 2024-205449

(51) Int. Cl. G06T 15/20; G06T 7/20; G06T 7/70; G06T 17/00

(52) U.S. Cl. CPC G06T 15/20; G06T 7/20; G06T 7/70; G06T 17/00; G06T 2207/30196

(57) ABSTRACT

An image processing system includes a system which records, while associating with each other, a three-dimensional (3D) model of a first subject generated with use of a plurality of captured images acquired by image capturing performed by a plurality of image capturing apparatuses and first time information, and a system which records, while associating with each other, second time information which is measured under a criterion different from that for the first time information and posture information indicating a posture of a second subject generated with use of a plurality of captured images acquired by image capturing performed by a plurality of image capturing apparatuses, converts the first time information to identify the second time information corresponding to the first time information, and generates a virtual viewpoint image based on the 3D model corresponding to the first time information and the posture information corresponding to the identified second time information.

### BACKGROUND

### Field of the Technology

The present disclosure relates to generation processing for a virtual viewpoint image.

### Description of the Related Art

Recently, a technique called “volumetric capture”, which is capable of generating a three-dimensional (3D) model of a subject from images captured by a plurality of cameras, has drawn attention. This technique is able to generate a 3D model from captured image data about a subject and, with use of a virtually arranged camera (virtual camera) which is operated as an optional viewpoint (arbitrary point of view), generate, as a virtual viewpoint image, such an image as not viewable with use of a camera arranged in a real space.

With regard to volumetric capture, for example, Japanese Patent Laid-Open No. 2022-70058 describes a method of capturing images of different spaces which are physically way from each other, such as a stadium and a studio, as subjects. This method captures images of different spaces with use of the same technique of volumetric capture and is thus able to substitute a part of a 3D model generated from one image capturing with a 3D model generated from the other image capturing. This enables combining 3D models obtained by the same systems and thus generating a single virtual viewpoint image.

On the other hand, as an image capturing method different from the above-mentioned method, there is a technique called “motion capture”.

This technique captures an image of a subject with, for example, markers worn thereon, acquires information indicating the posture of the subject (for example, the coordinates of the respective regions with the markers appended thereto), and appends the acquired information to a preliminarily set computer graphics (CG) model as an animation, and is thus able to move the CG model.

Recently, to provide an even more attractive virtual viewpoint image, it has been desirable to generate a single virtual viewpoint image with use of different pieces of data generated by different systems. For example, a 3D model of a subject is generated by a system which generates a virtual viewpoint image using volumetric capture, and skeletal information about a subject is generated by a system which generates a virtual viewpoint image using motion capture. Then, it is desirable to use these pieces of data to generate a virtual viewpoint image. However, since the respective systems have been designed as different systems, pieces of data generated by the respective systems differ in the management criterion for data generated by each system, so that it may be impossible to generate a virtual viewpoint image.

### SUMMARY

The present disclosure is directed to providing a contrivance which generates a virtual viewpoint image using pieces of data which are generated by different systems and are managed under different criteria.

According to an aspect of the present disclosure, an image processing system includes one or more memories storing instructions, and one or more processors executing the instructions to: record, while associating with each other, a three-dimensional (3D) model of a first subject generated with use of a plurality of captured images acquired by image capturing performed by a plurality of image capturing apparatuses and first time information, record, while associating with each other, second time information which is measured under a criterion different from that for the first time information and posture information indicating a posture of a second subject generated with use of a plurality of captured images acquired by image capturing performed by a plurality of image capturing apparatuses, convert the first time information to identify the second time information corresponding to the first time information, and generate a virtual viewpoint image based on the 3D model corresponding to the first time information and the posture information corresponding to the identified second time information.

Features of the present disclosure will become apparent from the following description of embodiments with reference to the attached drawings. The following description of embodiments is described by way of example.

### BRIEF DESCRIPTION OF THE DRAWINGS

FIGS. 1A, 1B, and 1C are configuration diagrams of an image processing system according to a first embodiment.

FIGS. 2A and 2B are configuration diagrams of an image generation apparatus according to the first embodiment.

FIGS. 3A, 3B, 3C, and 3D are diagrams used to explain an operation of a virtual camera according to one or more aspects of the present disclosure.

FIGS. 4A and 4B are flowcharts of storage processing for pieces of data generated by the respective systems according to one or more aspects of the present disclosure.

FIGS. 5A, 5B, 5C, and 5D are diagrams illustrating a configuration example of a database according to one or more aspects of the present disclosure.

FIGS. 6A, 6B, 6C, 6D, 6E, 6F, and 6G are diagrams used to explain processing for generating a virtual viewpoint image which is performed by the image processing system according to one or more aspects of the present disclosure.

FIG. 7 is a flowchart of image generation processing according to one or more aspects of the present disclosure.

FIG. 8 is a flowchart of storage processing for motion data according to one or more aspects of the present disclosure.

FIG. 9 is a diagram illustrating a configuration example of a database according to one or more aspects of the present disclosure.

### DESCRIPTION OF THE EMBODIMENTS

According to an aspect of the present disclosure, an image processing system includes a first system configured to record, while associating with each other, a three-dimensional (3D) model of a first subject generated with use of a plurality of captured images acquired by image capturing performed by a plurality of image capturing apparatuses and first time information. Moreover, the image processing system includes a second system configured to record, while associating with each other, second time information which is measured under a criterion different from that for the first time information and posture information indicating a posture of a second subject generated with use of a plurality of captured images acquired by image capturing performed by a plurality of image capturing apparatuses. Moreover, the image processing system includes an identification unit configured to convert the first time information to identify the second time information corresponding to the first time information. Moreover, the image processing system includes a generation unit configured to generate a virtual viewpoint image based on the 3D model corresponding to the first time information and the posture information corresponding to the identified second time information.

Furthermore, the second time information which is measured under a criterion different from that for the first time information is, for example, information indicating time which is counted at a frame rate different from that for the first time information. Specifically, the second time information is information indicating time which is counted at a frame rate higher than that for the first time information. Alternatively, the second time information can be information indicating time which is counted in a unit different from that for the first time information.

According to this aspect, the image processing system is able to generate a virtual viewpoint image with use of pieces of data which are generated by respective different systems and are managed under respective different criteria.

Moreover, the image processing system includes an interpolation unit configured to, in a case where the second time information corresponding to the first time information is not currently recorded, make an interpolation for the posture information corresponding to the second time information based on pieces of time information measured before and after the second time information. Moreover, the generation unit generates a virtual viewpoint image based on the 3D model corresponding to the first time information and the posture information subjected to the interpolation.

According to this aspect, even if, in pieces of data which are managed under respective different criteria, there is no correspondence between pieces of data which are generated by respective different systems, it is possible to generate a virtual viewpoint image.

Moreover, the virtual viewpoint image is generated based on the 3D model corresponding to the first time information and a preliminarily generated 3D model associated with the posture information corresponding to the identified second time information and different from the 3D model corresponding to the first time information.

Moreover, the posture information is information indicating positions of respective regions of the second subject. The respective regions are, for example, respective joints. Alternatively, in the case of motion capture using markers, the respective regions are regions with the respective markers appended thereto. Furthermore, the posture information only needs to be information indicating the posture of the second subject, and can be, for example, information indicating the skeleton of the second subject. Furthermore, the posture information is also referred to as “skeleton”, “armature”, or “motion data”.

Furthermore, the first system is a system for volumetric capture, and the second system is a system for motion capture.

According to another aspect of the present disclosure, an image processing method includes recording, while associating with each other, a three-dimensional (3D) model of a first subject generated with use of a plurality of captured images acquired by image capturing performed by a plurality of image capturing apparatuses and first time information. Moreover, the image processing method includes recording, while associating with each other, second time information which is measured under a criterion different from that for the first time information and posture information indicating a posture of a second subject generated with use of a plurality of captured images acquired by image capturing performed by a plurality of image capturing apparatuses. Moreover, the image processing method includes converting the first time information to identify the second time information corresponding to the first time information. Moreover, the image processing method includes generating a virtual viewpoint image based on the 3D model corresponding to the first time information and the posture information corresponding to the identified second time information.

According to a further aspect of the present disclosure, a non-transitory computer-readable storage medium stores a program for causing a computer to execute an image processing method, including recording, while associating with each other, a three-dimensional (3D) model of a first subject generated with use of a plurality of captured images acquired by image capturing performed by a plurality of image capturing apparatuses and first time information, recording, while associating with each other, second time information which is measured under a criterion different from that for the first time information and posture information indicating a posture of a second subject generated with use of a plurality of captured images acquired by image capturing performed by a plurality of image capturing apparatuses, converting the first time information to identify the second time information corresponding to the first time information, and generating a virtual viewpoint image based on the 3D model corresponding to the first time information and the posture information corresponding to the identified second time information.

Various embodiments, features, and aspects of the present disclosure will be described in detail below with reference to the accompanying drawings. Furthermore, the following embodiments are not construed to limit the scope of the present disclosure set forth in claims. While a plurality of features is described in each embodiment, not all of the plurality of features should not be construed to be essential for the present disclosure, and, moreover, the plurality of features can be combined in an optional manner. Additionally, in the accompanying drawings, the same or similar constituent elements are assigned the respective same reference numerals, and any duplicate description thereof is omitted.

### First Embodiment

In the description of a first embodiment, a plurality of different image capturing systems uses volumetric capture and motion capture to perform image capturing of different spaces, respectively. Volumetric capture is used to generate a three-dimensional model of a subject, and motion capture is used to generate information indicating a posture of a subject. Then, a virtual viewpoint image is based on such generated pieces of data.

The information indicating the posture of a subject which is generated by motion capture is information which is referred to as “skeleton”. Moreover, such information is not only referred to as “skeleton” but also may be referred to as “armature” or “motion data”. In the first embodiment, such information is referred to as “motion data”.

### [Configuration of Virtual Viewpoint Image Generation System]

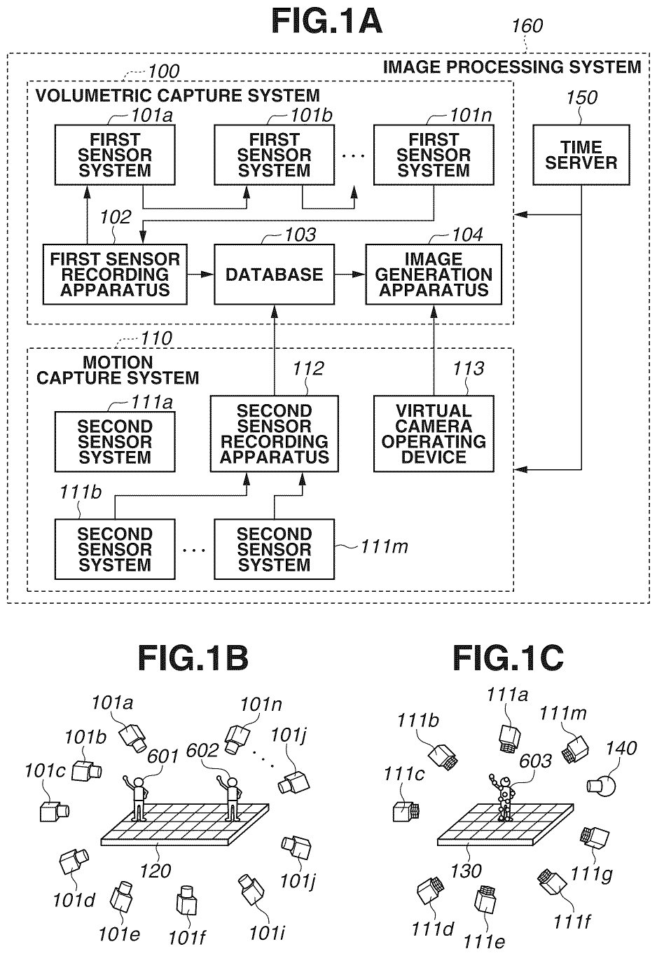

FIGS. 1A, 1B, and 1C illustrate a configuration of an image processing system 160 according to the first embodiment.

FIG. 1A is a configuration diagram of the image processing system 160. The image processing system 160 includes a plurality of image capturing systems. In the first embodiment, the image processing system 160 is assumed to include a volumetric capture system 100 serving as a first image capturing system, a motion capture system 110 serving as a second image capturing system, and a time server 150. Furthermore, while, in the present disclosure, the time server 150, which is used in common, manages image capturing time of each of the image capturing systems, the first embodiment is not limited to this. The plurality of image capturing systems can include the respective time servers.

### [Description of Volumetric Capture System 100]

As illustrated in FIG. 1A, the volumetric capture system 100 includes n first sensor systems, i.e., a first sensor system 101a to a first sensor system 101n.

Each sensor system in volumetric capture includes, as at least one image capturing apparatus, a visible light camera (a red-green-blue (RGB) camera, hereinafter referred to simply as a “camera”). In the following description, unless otherwise noted, n first sensor systems are not differentiated but are referred to as a “plurality of first sensor systems 101”. In the first embodiment, the plurality of first sensor systems 101 is interconnected like beads on a string, and collectively transmits pieces of information generated by the respective first sensor systems 101 to a first sensor recording apparatus 102. Furthermore, the first embodiment is not limited to this configuration, and a configuration in which each of the first sensor systems 101 transmits information to the first sensor recording apparatus 102 can be employed.

FIG. 1B is a diagram illustrating an example of installation of the plurality of first sensor systems 101. The plurality of first sensor systems 101 is installed in such a way as to surround a first image capturing area 120, which is a target area for image capturing, and performs image capturing of the first image capturing area 120 from respective different directions.

In the example in the first embodiment, the first image capturing area 120 targeted for image capturing is assumed to be a stage in a studio in which, for example, the live musical performance of an artist is performed, and n (for example, 100) first sensor systems 101 are assumed to be installed in such a way as to surround the stage. Furthermore, the number of first sensor systems 101 to be installed is not limited, and the first image capturing area 120 targeted for image capturing is not limited to a stage in a studio. For example, the first image capturing area 120 can contain a set placed on the stage, or the first image capturing area 120 can be, for example, an arena or an outdoor stadium.

A subject of which the volumetric capture system 100 serving as the first image capturing system performs image capturing is referred to as a “first subject”. In the example illustrated in FIG. 1B, the first subject includes a subject 601 and a subject 602 who are situated in the first image capturing area 120 and are performing a musical performance or acting performance.

Moreover, the plurality of first sensor systems 101 does not need to be installed all around the first image capturing area 120, but can be installed at only a part of the circumference of the first image capturing area 120 due to, for example, installation location restrictions. Moreover, a plurality of cameras included in the plurality of first sensor systems 101 can include image capturing apparatuses differing in function, such as a telephoto camera and a wide-angle camera.

A plurality of cameras included in the plurality of first sensor systems 101 synchronously performs image capturing. To perform synchronous image capturing, the volumetric capture system 100 is configured to be connected to the time server 150 and uses a timecode as image capturing time.

The timecode is information for uniquely identifying image capturing time in the volumetric capture system 100, and is designated in a form such as “day: hour: minute: second. frame number”.

While, in the first embodiment, the image capturing rate of the volumetric capture system 100 is assumed to be 59.94 frames per second (FPS), the first embodiment is not limited to this value.

In the present disclosure, a timecode which is image capturing time of the volumetric capture system 100 serving as the first image capturing system is referred to as “first image capturing time”.

The plurality of first sensor systems 101 can include, in addition to cameras, microphones (not illustrated).

The respective microphones of the plurality of first sensor systems 101 synchronously collect sound. Based on the collected sound, an audio signal which is reproduced together with image display performed by an image generation apparatus 104 can be generated. While, in the following description, for ease of explanation, the description regarding a sound is omitted, basically, an image and a sound are assumed to be processed together.

The first sensor recording apparatus 102 acquires a plurality of captured images from the plurality of first sensor systems 101 and then stores, in a database 103, the plurality of captured images while associating the plurality of captured images with a timecode for the time of image capturing.

### [Description of Motion Capture System 110]

As illustrated in FIG. 1A, the motion capture system 110 serving as the second image capturing system includes m second sensor systems, i.e., a second sensor system 111a to a second sensor system 111m. Each sensor system in motion capture includes an infrared camera. Furthermore, the camera included in each sensor system is not necessarily limited to an infrared camera, but can be, for example, a high-speed camera. In the following description, unless otherwise noted, m second sensor systems are not differentiated but are referred to as a “plurality of second sensor systems 111”.

FIG. 1C is a diagram illustrating an example of installation of the plurality of second sensor systems 111. The plurality of second sensor systems 111 is installed in such a way as to surround a second image capturing area 130, which is a target area for image capturing, and performs image capturing of the second image capturing area 130 from respective different directions.

In the example in the first embodiment, the second image capturing area 130 targeted for image capturing is assumed to be a stage in a studio in which, for example, the live musical performance of an artist is performed, and m (for example, 20) second sensor systems 111 are assumed to be installed in such a way as to surround the stage. The second image capturing area 130 targeted for image capturing is not limited to a stage in a studio. For example, the second image capturing area 130 can contain a set placed on the stage or can be, for example, an arena or an outdoor stadium.

A subject of which the motion capture system 110 serving as the second image capturing system performs image capturing is referred to as a “second subject”. In the example illustrated in FIG. 1C, the second subject includes a subject 603 who is situated in the second image capturing area 130 and is performing a musical performance or acting performance while appending markers to the respective regions thereof.

While, in the first embodiment, the first subject and the second subject are present in the respective different image capturing areas 120 and 130, for example, remote cameras are used to mutually confirm motions of both of the first and second subjects and thus enable, for example, conversations. Here, both of the first and second subjects are assumed to perform the same music and perform the same motion such as the same choreography.

The motion capture system 110 uses the infrared cameras included in the plurality of second sensor systems 111, tracks motions of the markers appended to the second subject, and acquires coordinate values in a three-dimensional physical space of the respective regions with the markers appended thereto. The markers are appended to respective portions such as head, face, shoulder, breast, right arm, left arm, right hand, left hand, waist, right foot, and left foot as the respective regions of the second subject and thus enable accurately tracking motions of the entire subject. Such a motion capture technique is known and, therefore, the detailed description thereof is omitted.

The plurality of second sensor systems 111 can include, in addition to cameras, microphones (not illustrated).

The respective microphones of the plurality of second sensor systems 111 synchronously collect sound. Based on the collected sound, an audio signal which is reproduced together with image display performed by the image generation apparatus 104 can be generated. While, in the following description, for ease of explanation, the description regarding a sound is omitted, basically, an image and a sound are assumed to be processed together.

A second sensor recording apparatus 112 converts the three-dimensional coordinates which the plurality of second sensor systems 111 has acquired into motion data and then stores, in the database 103 of the volumetric capture system 100 serving as the first image capturing system, the motion data along with a system elapsed time obtained at the time of image capturing.

The system elapsed time is information for uniquely identifying image capturing time in the motion capture system 110 and specifies, for example, a time in “seconds” with an accuracy of microsecond.

Furthermore, as long as a value indicates the system elapsed time, the form of the value is not limited to a time in seconds.

Furthermore, the system elapsed time is generated based on time information which is acquired from the time server 150. A configuration in which a time at which the motion capture system 110 has started is preliminarily retained and a time having elapsed from such start time is used as the system elapsed time can be employed.

While, in the first embodiment, the image capturing rate of the motion capture system 110 is assumed to be 240 FPS, the first embodiment is not limited to this value.

In the present disclosure, a system elapsed time which is image capturing time of the motion capture system 110 serving as the second image capturing system is referred to as “second image capturing time”. Furthermore, the second image capturing time is not limited to the system elapsed time as long as long as it indicates image capturing time of the second image capturing system.

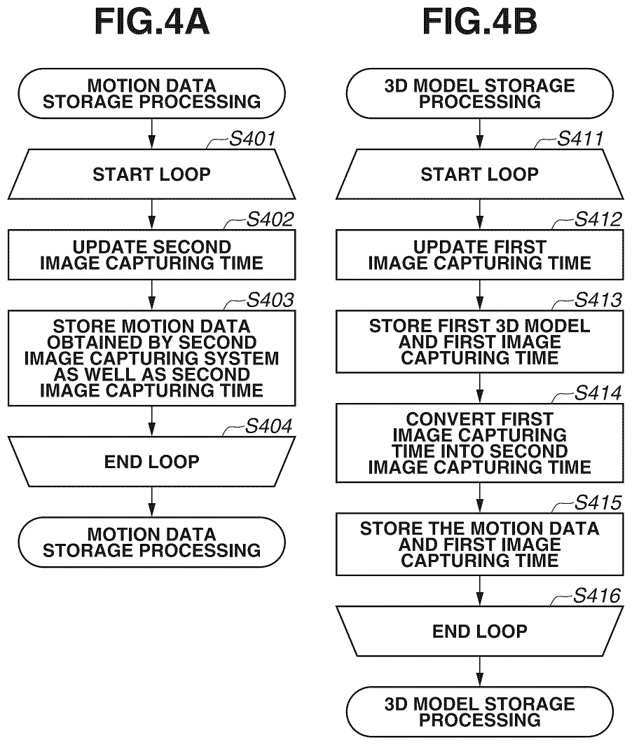

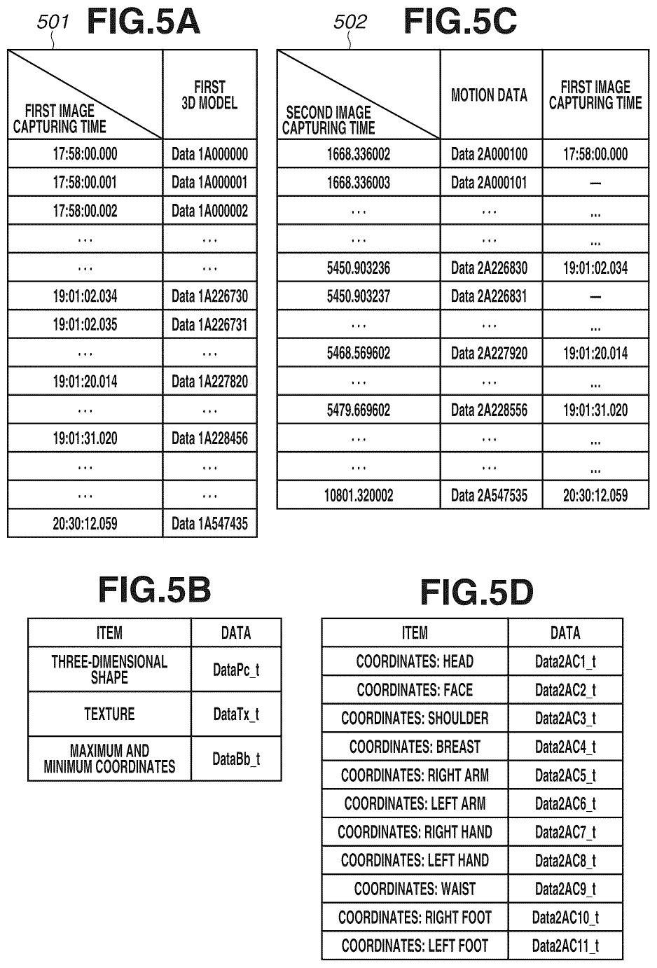

In the present disclosure, the first image capturing time and the second image capturing time are generated based on time information which is acquired from the same time server 150. Therefore, the volumetric capture system 100 serving as the first image capturing system and the motion capture system 110 serving as the second image capturing system are able to perform processing in temporal synchronization with each other. This synchronous processing is described below with reference to FIGS. 4A and 4B and FIGS. 5A, 5B, 5C, and 5D.

Furthermore, there is a difference in that a timecode, which is the first image capturing time of the volumetric capture system 100, is in units of frames but a system elapsed time, which is the second image capturing time of the motion capture system 110, is in units of seconds.

The image generation apparatus 104 acquires, from the database 103, pieces of captured image data obtained by the respective image capturing systems or 3D models generated from the pieces of captured image data, and thus generates a virtual viewpoint image.

The virtual viewpoint image which the image generation apparatus 104 generates is an image representing the appearance of a subject viewed from a virtual camera 140 (FIG. 1C). Since the virtual camera is not subjected to physical restrictions in installment, the virtual viewpoint image is also called a “free viewpoint video image”. Furthermore, the virtual viewpoint image can be displayed on, for example, a display of the image generation apparatus 104 or can be output to an external system.

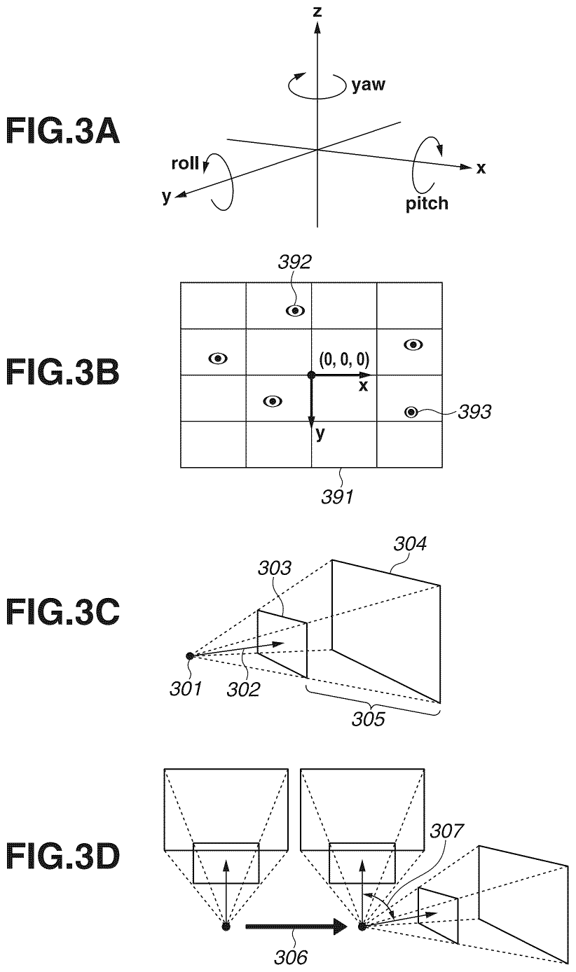

The virtual camera 140 is operated by a virtual camera operating device 113. The virtual camera 140 is set within a virtual space associated with the first image capturing area 120 and the second image capturing area 130 and enables viewing the virtual space from a viewpoint different from that for any camera included in the plurality of first sensor systems 101 and the plurality of second sensor systems 111. The virtual camera 140 and an operation thereof are described below with reference to FIGS. 3A, 3B, 3C, and 3D.

In the first embodiment, as illustrated in FIG. 1A, the virtual camera operating device 113 is assumed to be included in the motion capture system 110, which is higher in image capturing rate, in the plurality of image capturing systems. Furthermore, a configuration in which the virtual camera operating device 113 includes a display unit such as a display and displays three-dimensional coordinate information about motion data acquired from the motion capture system 110 can be employed. Moreover, a configuration in which the virtual camera operating device 113 displays a 3D model which is generated from motion data described below can be employed.

Furthermore, a configuration in which the image generation apparatus 104 and the virtual camera operating device 113 are integrated with each other can be employed. In this case, the virtual camera 140 is operated in a virtual space in which a 3D model generated by volumetric capture and a 3D model with the posture thereof changed by motion data generated by motion capture are arranged. Moreover, a configuration in which the virtual camera operating device 113 is included in the first image capturing system can be employed.

Furthermore, the configuration of the image processing system 160 is not limited to the example illustrated in FIG. 1A. The number of image capturing systems is not limited to two but can be greater than two. The image capturing method is not limited to volumetric capture or motion capture but can be any other image capturing method.

Furthermore, while, in the description of the example illustrated in FIG. 1A, the database 103 and the image generation apparatus 104 are separate units, a configuration in which the database 103 and the image generation apparatus 104 are integrated with each other can be employed.

Thus far is the description of the configurations of the volumetric capture system 100 and the motion capture system 110 as a plurality of different image capturing systems for use in the first embodiment.

### [Functional Configuration of Image Generation Apparatus 104]

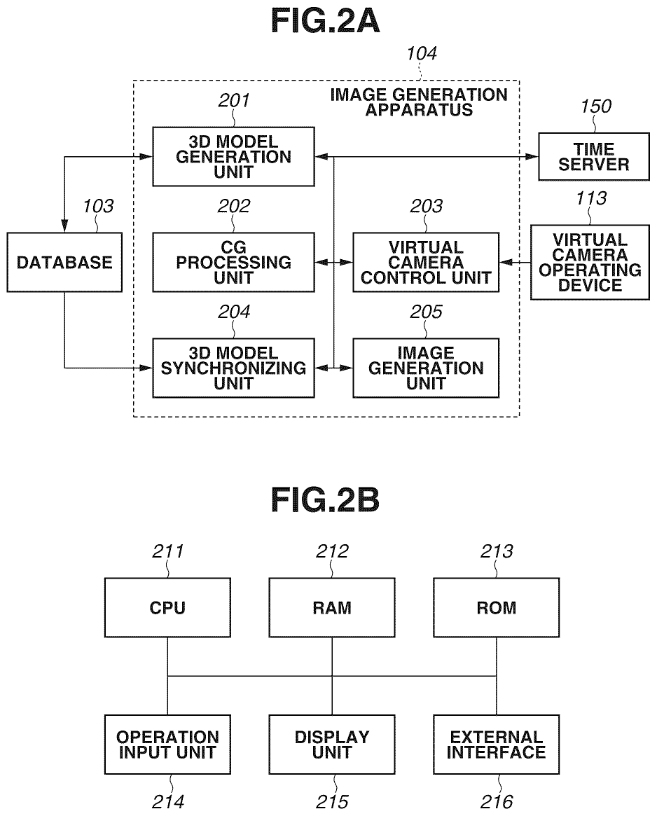

FIGS. 2A and 2B are configuration diagrams of the image generation apparatus 104 according to the first embodiment.

FIG. 2A is a diagram illustrating an example of a functional configuration of the image generation apparatus 104. The image generation apparatus 104 uses three-dimensional models which are generated by respective different image capturing systems to generate a virtual viewpoint image. The image generation apparatus 104 includes a 3D model generation unit 201, a computer graphics (CG) processing unit 202, a virtual camera control unit 203, a 3D model synchronizing unit 204, and an image generation unit 205.

The 3D model generation unit 201 uses a plurality of captured images obtained by the volumetric capture system 100 serving as the first image capturing system acquired from the database 103 with a timecode specified, and thus generates a three-dimensional model representing a three-dimensional shape of the subject present in the image capturing area 120. The 3D model generation unit 201 acquires, from the plurality of captured images, a foreground image obtained by extracting a foreground region corresponding to an object such as a person or musical instrument and a background image obtained by extracting a background region which is other than the foreground region. Then, the 3D model generation unit 201 generates a foreground 3D model (three-dimensional model) based on a plurality of foreground images.

In the present disclosure, a 3D model which is generated from a plurality of captured images obtained by the volumetric capture system 100 serving as the first image capturing system is referred to as a “first 3D model”.

The first 3D model is, for example, three-dimensional shape data which is generated by a shape estimation method such as a volume intersection method (visual hull) and is composed of a point cloud. Furthermore, the form of three-dimensional shape data representing the shape of a subject is not limited to this. For example, the 3D model of a subject can be a mesh model.

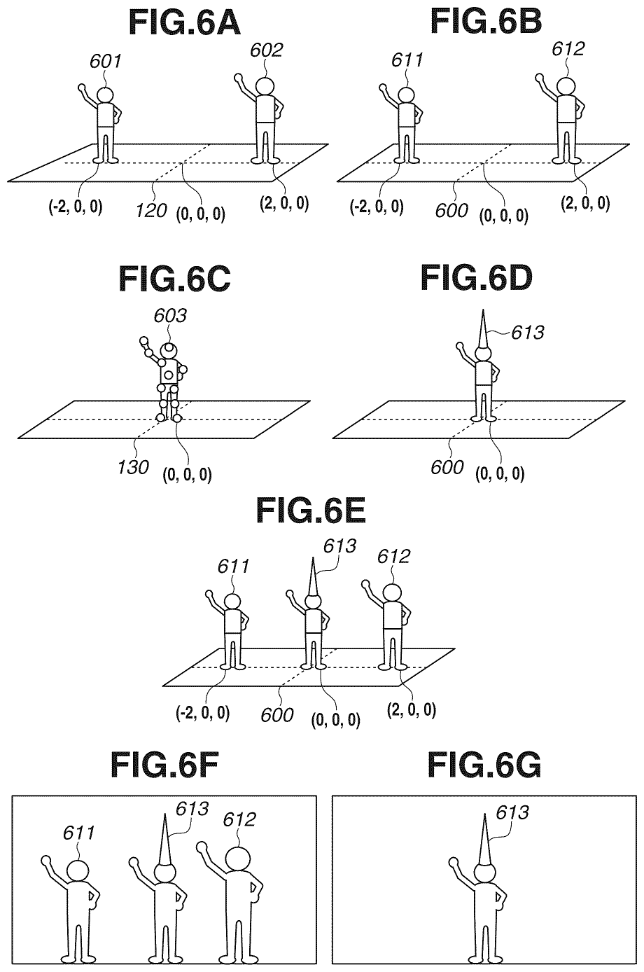

The 3D model generation unit 201 stores, in the database 103, the generated first 3D model along with a timecode (first image capturing time). A configuration example of a file obtained by associating the first 3D model and the first image capturing time, to be stored in the database 103, with each other is described below with reference to FIGS. 5A to 5D. Moreover, a configuration example of a file representing the details of the first 3D model is described below with reference to FIGS. 6A, 6B, 6C, 6D, 6E, 6F, and 6G.

Furthermore, a configuration in which the 3D model generation unit 201 is included in not the image generation apparatus 104 but the first sensor recording apparatus 102 can be employed. In that case, a configuration in which the first sensor recording apparatus 102 stores the first 3D model in the database 103 and the image generation apparatus 104 reads out and uses the first 3D model from the database 103 is employed.

The CG processing unit 202 acquires, from the database 103, motion data which the motion capture system 110 serving as the second image capturing system has stored. The CG processing unit 202 performs processing for associating the acquired motion data with a preliminarily generated CG model. This processing is used to move a preliminarily generated 3D model with use of motion data which is acquired from the motion capture system 110 serving as the second image capturing system. Furthermore, this processing is called “rigging” and is general processing, and, therefore, the detailed description thereof is omitted. For the sake of convenience, data which is acquired from the motion capture system 110 serving as the second image capturing system is referred to as “motion data”. Furthermore, while, in the first embodiment, the preliminarily generated CG model is preliminarily recorded on the CG processing unit 202, the first embodiment is not limited to this, and the preliminarily generated CG model can be preliminarily recorded on the database 103.

Moreover, in the present disclosure, a 3D model which is the preliminarily generated CG model and the posture of which has been changed with use of motion data generated by the motion capture system 110 is referred to as a “second 3D model”. This 3D model is also referred to as a “CG model”. Furthermore, in the first embodiment, processing for changing the posture of a 3D model with use of motion data is reworded as processing for generating the second 3D model.

The virtual camera control unit 203 receives, from the virtual camera operating device 113, input information for the virtual camera 140 and thus updates the position and orientation of the virtual camera 140. Moreover, the virtual camera control unit 203 receives input information for a timecode and thus updates the timecode. For the operation on the virtual camera 140, for example, a touch panel, a joystick, and a keyboard are used. Then, the virtual camera control unit 203 outputs, to the image generation unit 205, information indicating the updated position and orientation of the virtual camera 140 as viewpoint information. Furthermore, in the first embodiment, the virtual camera control unit 203 also outputs, in addition to the viewpoint information, the updated timecode to the image generation unit 205. Furthermore, the virtual camera control unit 203 can acquire input information via an operation performed on another input device. Moreover, the virtual camera control unit 203 can use a preliminarily set path of the virtual camera 140. An operation of the virtual camera 140 is described below with reference to FIGS. 3A to 3D.

The 3D model synchronizing unit 204 synchronizes the first 3D model and the second 3D model, which have been generated from pieces of captured image data obtained by the respective image capturing systems, with each other, and then arranges the synchronized first 3D model and second 3D model in a single virtual space. The synchronous processing is described below with reference to FIGS. 4A and 4B.

The image generation unit 205 generates a virtual viewpoint image based on the first 3D model and second 3D model arranged by the 3D model synchronizing unit 204 and the viewpoint information about the virtual camera 140 set by the virtual camera control unit 203.

Thus far is the description of a functional configuration of the image generation apparatus 104 in the first embodiment.

### [Hardware Configuration of Image Generation Apparatus 104]

Next, a hardware configuration of the image generation apparatus 104 is described with reference to FIG. 2B.

The image generation apparatus 104 includes a central processing unit (CPU) 211, a random access memory (RAM) 212, and a read-only memory (ROM) 213.

Moreover, the image generation apparatus 104 includes an operation input unit 214, a display unit 215, and an external interface 216.

The CPU 211 performs processing with use of programs and data which are stored in the RAM 212 and the ROM 213. The CPU 211 performs operation control of the entire image generation apparatus 104, and performs processing operations for implementing the respective functions illustrated in FIG. 2A.

Furthermore, the image generation apparatus 104 can include one or a plurality of dedicated pieces of hardware different from the CPU 211, and the dedicated pieces of hardware can perform at least a part of processing which is to be performed by the CPU 211.

Examples of the dedicated pieces of hardware include an application specific integrated circuit (ASIC), a field programmable gate array (FPGA), and a digital signal processor (DSP).

The ROM 213 retains programs and data. The RAM 212 has a work area for temporarily storing programs and data read out from the ROM 213. Moreover, the RAM 212 provides a work area used for the CPU 211 to perform the respective processing operations.

The operation input unit 214 is, for example, a touch panel and acquires information about an operation performed by the user.

For example, the operation input unit 214 receives operations performed on the virtual camera 140 or the timecode. Furthermore, the operation input unit 214 can be connected to an external controller and receives, from the external controller, input information concerning an operation. Furthermore, the external controller is, for example, a three-axis controller, such as a joystick, or a mouse. Furthermore, the external controller is not limited to these.

The display unit 215 is, for example, a touch panel or a screen and displays a virtual viewpoint image. In a case where the display unit 215 is a touch panel, the operation input unit 214 and the display unit 215 are configured to be integrated with each other.

The external interface 216 performs, for example, transmission and reception of information with respect to, for example, the database 103 or the time server 150 via, for example, a local area network (LAN). For example, the external interface 216 can transmit, for example, a virtual viewpoint image to, for example, an external screen via an image output port for, for example, a high-definition multimedia interface (HDMI®) or a serial digital interface (SDI). For example, the external interface 216 can transmit a virtual viewpoint image via, for example, Ethernet.

Thus far is the description of a hardware configuration of the image generation apparatus 104 in the first embodiment.

### [Virtual Camera 140]

An operation of the virtual camera 140 (or a virtual viewpoint) is described with reference to FIGS. 3A to 3D. For the purpose of description of the operation, in first, for example, the position, orientation, and visual frustum of the virtual camera 140 are described.

The virtual camera 140 and an operation thereof are specified with use of a single coordinate system. The coordinate system to be used is a general three-dimensional orthogonal coordinate system composed of an X-axis, Y-axis, and Z-axis illustrated in FIG. 3A.

The coordinate system units to be used are, for example, metric units.

Since, naturally, the virtual camera 140 and 3D models are used in the same virtual space, the coordinate system is used even for the first 3D model and the second 3D model.

The coordinate system is set to an image capturing target and is used therefor. Examples of the image capturing target are a studio and a field in a stadium. As illustrated in FIG. 3B, the image capturing target includes the entire stage 391 of the stadium and also includes, for example, a performer 393 and an object 392 which are present on the stage 391. Furthermore, the subject can contain, for example, the audience around the studio, and is not particularly limited.

With regard to the setting of the coordinate system to the image capturing target, the center of the stage 391 is set as an origin (0, 0, 0).

Moreover, the X-axis is set as a longitudinal direction of the stage 391, the Y-axis is set as a widthwise direction of the stage 391, and the Z-axis is set as a direction normal to the stage 391. Furthermore, the settings of the coordinate system are not limited to these.

Next, the virtual camera is described with reference to FIGS. 3C and 3D. The virtual camera is a thing serving as a viewpoint for drawing a virtual viewpoint image. In a quadrangular pyramid illustrated in FIG. 3C, the vertex represents the position 301 of the virtual camera, and a vector extending from the vertex represents the orientation 302 of the virtual camera. The position of the virtual camera is expressed by the coordinates (x, y, z) in a three-dimensional space, and the orientation of the virtual camera is expressed by a unit vector with components of the respective axes set as scalars.

The orientation 302 of the virtual camera is assumed to pass through the center points of a front clipping plane 303 and a far clipping plane 304. Moreover, a space 305 sandwiched between the front clipping plane 303 and the far clipping plane 304 is called a “visual frustum of the virtual camera”, and serves as a range in which the image generation unit 205 generates a virtual viewpoint image (or a range in which the image generation unit 205 projects and displays a virtual viewpoint image, hereinafter referred to as a “display region of the virtual viewpoint image”).

The orientation 302 of the virtual camera is expressed by a vector and is also called an “optical axis vector of the virtual camera”.

The move and rotation of the virtual camera are described with reference to FIG. 3D. The virtual camera moves and rotates within a space expressed by three-dimensional coordinates.

The move 306 of the virtual camera is the move of the position 301 of the virtual camera and is expressed by components (x, y, z) of the respective axes. The rotation 307 of the virtual camera is, as illustrated in FIG. 3A, expressed by the yaw being a rotation around the Z-axis, the pitch being a rotation around the X-axis, and the roll being a rotation around the Y-axis.

As mentioned above, designating the X-, Y-, and Z-coordinates (x, y, z) of the virtual camera and the rotation angles (pitch, roll, yaw) of the X-axis, Y-axis, and Z-axis enables freely operating the image capturing position and direction of the virtual camera.

These enable the virtual camera to freely move and rotate a three-dimensional virtual space in which to arrange a 3D model generated from a subject, so that it is possible to generate an optional region in the virtual space as a virtual viewpoint image.

Furthermore, the operation of the virtual camera is not limited to these, but only needs to be an operation which is able to be implemented by a combination of the move and rotation of the virtual camera.

Thus far is the description of the position and orientation of the virtual camera in the first embodiment.

### [3D Model Storage Processing, Database Configuration, and 3D Model Example]

FIGS. 5A to 5D are diagrams illustrating a configuration example of the database 103 according to the first embodiment.

FIG. 5A is a diagram illustrating a table for storing the first 3D model generated by the volumetric capture system 100 serving as the first image capturing system. This table is referred to as a “first table 501”. In the first table 501, the first image capturing time and the first 3D model are recorded while being associated with each other.

FIG. 5B is a diagram illustrating a table showing a configuration of the first 3D model. The first 3D model retains therein data indicating a three-dimensional shape, data indicating a texture, and data indicating the maximum and minimum coordinates. Furthermore, the first 3D model can further retain, for example, an identifier of a subject which a three-dimensional shape represents.

The three-dimensional shape is information indicating three-dimensional coordinates (DataPc_t) of all of the point clouds of the first 3D model. Furthermore, in a case where the first 3D model is a mesh model, the three-dimensional shape includes, in addition to the coordinates of vertices of the respective planes constituting the mesh model, information indicating a combination of vertices constituting each plane. The texture is a texture image (DataTx_t) acquired from a captured image to be applied to the above-mentioned point cloud. Furthermore, the texture image can be a plurality of captured images. The maximum and minimum coordinates are the maximum and minimum values (DataBb_t) of each axis in three-dimensional coordinates of the above-mentioned point cloud and is also called a “bounding box”. The first 3D model is arranged in the same virtual space as that for the second 3D model and is, therefore, generated as a universal format of, for example, a colored point cloud.

Moreover, the first 3D model and the second 3D model are generated based on the same coordinate system. Specifically, the coordinate system of a real space in the volumetric capture system 100 which generates the first 3D model and the coordinate system of a real space in the motion capture system 110 which generates motion data for generating the second 3D model are aligned with each other. Furthermore, the configuration of the first 3D model is not limited to these, but only needs to be a configuration which is able to be arranged in the same virtual space as that for the second 3D model.

Furthermore, as long as the first 3D model is a 3D model which is generated by the volumetric capture system 100, the data configuration thereof is not limited to these. Furthermore, while, for ease of explanation, even a plurality of subjects is treated as one 3D model, a plurality of 3D models can be stored for the respective subjects.

FIG. 5C is a diagram illustrating a table for storing motion data which is acquired by the motion capture system 110 serving as the second image capturing system. This table is referred to as a “second table 502”. In the second table 502, the second image capturing time, the motion data, and the first image capturing time are recorded.

FIGS. 6A to 6G are diagrams used to explain processing for generating a virtual viewpoint image in the image processing system 160 according to the first embodiment. The details thereof are described below.

FIGS. 4A and 4B are flowcharts of storage processing for pieces of data generated by the respective systems according to the first embodiment.

FIG. 4A is a flowchart of processing for storing motion data which is generated by the motion capture system 110 in the database 103. In the motion capture system 110, the second sensor recording apparatus 112 stores motion data which is acquired by the motion capture system 110 in the second table 502 of the database 103.

In step S401 to step S404, the second sensor recording apparatus 112 repeats storage processing for motion data according to an image capturing interval (frame rate) of the motion capture system 110. In a case where the image capturing frame rate is 240 FPS, the second sensor recording apparatus 112 repeats the storage processing at intervals of about 4.16 milliseconds.

In step S402, the second sensor recording apparatus 112 updates the system elapsed time, which is the second image capturing time. For example, the system elapsed time is incremented according to the image capturing rate. Furthermore, the system elapsed time can be connected to the time server 150 via, for example, Network Time Protocol (NTP) and thus be updated as needed. Moreover, the start time of the motion capture system 110 can be preliminarily stored (not illustrated) in the second table 502 of the database 103 and an elapsed time from the stored start time can be used as the system elapsed time.

In step S403, the second sensor recording apparatus 112 stores, in the second table 502 of the database 103, motion data acquired from the motion capture system 110 along with the current system elapsed time being the second image capturing time. As one example, in a record in the fifth row of the second table 502 illustrated in FIG. 5C, motion data “Data 2A226830” is currently stored for the system elapsed time “5450.903236”

Next, FIG. 5D illustrates a configuration of motion data which is generated by the motion capture system 110. As illustrated in FIG. 5D, the motion data includes three-dimensional coordinates of the respective markers appended to the second subject which are stored as the respective region coordinates. In the first embodiment, the head, face, shoulder, breast, right arm, left arm, right hand, left hand, waist, right foot, and left foot are used as examples of the regions with the respective markers appended thereto, and the respective coordinates of those regions (Data2AC1_t to Data2AC11_t) constitute the motion data.

The motion capture system 110 can store CG data (not illustrated) in the database 103. The CG data can be stored without depending on any system elapsed time and be applied to pieces of motion data for all of the system elapsed times. Furthermore, pieces of CG data different for each system elapsed time can be used.

In step S404, the second sensor recording apparatus 112 returns the processing to step S401 and then repeats the above-mentioned motion data storage processing according to the image capturing interval of the motion capture system 110.

An example of the second subject in the motion capture system 110 serving as the second image capturing system, for which the motion data storage processing illustrated in FIG. 4A has been performed, and an example of the second 3D model, which is generated from those, are described with reference to FIGS. 6C and 6D.

FIG. 6C is a diagram illustrating an appearance in which the motion capture system 110 serving as the second image capturing system is performing image capturing. Markers are appended to the respective regions of the second subject 603 present in the second image capturing area 130, and the second subject 603 performs, for example, a musical performance or acting performance. The case example illustrated in FIG. 6C is an example of a scene in which the second subject 603 is raising his or her hand. In the motion capture system 110, the coordinates of the respective markers appended to the second subject 603 are acquired as motion data. Here, as an example, it is assumed that the system elapsed time is “5450.903236”, motion data “Data 2A226830” is associated therewith, and such system elapsed time and motion data are stored in the second table 502.

FIG. 6D illustrates a second 3D model 613 obtained by the CG processing unit 202 in the image generation apparatus 104 acquiring the motion data from the second table 502 and associating the acquired motion data with a preliminarily generated CG model. The second 3D model is, in other words, a CG model the posture of which has been changed by motion data. Therefore, the second 3D model 613 is a 3D model for the above-mentioned system elapsed time “5450.903236”. As illustrated in FIG. 6D, the motion capture system 110 is able to accurately acquire the coordinates of the respective markers appended to the second subject, and the second 3D model generated with the acquired coordinates appended as an animation is subjected to reflection of a positional relationship in the real space.

For example, assuming that, in FIG. 6C, the standing position of the second subject 603 is in the vicinity of (x, y, z)=(0, 0, 0), the standing position on a three-dimensional virtual space of a second 3D model 613 which is generated becomes (x, y, z)=(0, 0, 0).

Moreover, in FIG. 6D, the second 3D model 613 is subjected to reflection of a scene in which the second subject 603 is raising his or her hand.

In the motion capture system 110, not all of the coordinates of the second subject in the real space are reflected in a 3D model, but only coordinates of the regions with markers appended thereto are reflected in the second 3D model.

Furthermore, data to be retained in the database 103 is not limited to motion data. For example, a second 3D model obtained by applying motion data to CG data can be stored in the second table 502 for each system elapsed time.

Furthermore, the motion capture system 110 does not necessarily need to be a motion capture system which uses markers. For example, the motion capture system 110 can be a marker-less motion capture system which uses image recognition to acquire coordinates of the respective regions of the second subject.

Thus far is the description of the motion data storage processing in the first embodiment.

Next, a flowchart of 3D model storage processing in the first embodiment is described with reference to FIG. 4B.

The 3D model storage processing is processing for storing the first 3D model, which is generated by the volumetric capture system 100 serving as the first image capturing system, in the first table 501 of the database 103.

Moreover, the 3D model storage processing serves as processing for additionally storing, in addition to the second image capturing time, the first image capturing time in the second table 502 with respect to the motion data which is generated by the second image capturing system.

In the image generation apparatus 104, mainly, the 3D model synchronizing unit 204 performs these processing operations in cooperation with other functional blocks.

In step S411 to step S416, the 3D model synchronizing unit 204 repeats the 3D model storage processing. In the first embodiment, the 3D model synchronizing unit 204 repeats the 3D model storage processing according to an image capturing frame rate of the volumetric capture system 100 serving as the first image capturing system. For example, in a case where the image capturing frame rate is 59.94 FPS, the 3D model synchronizing unit 204 repeats the 3D model storage processing at intervals of about 16.667 milliseconds.

In step S412, the 3D model synchronizing unit 204 updates the timecode, which is the first image capturing time of the volumetric capture system 100 serving as the first image capturing system. For example, a frame number in the form of timecode “day: hour: minute: second. frame number” is incremented. Furthermore, increment of the timecode can be performed by, for example, a timecode generator included in the volumetric capture system 100. Here, as an example, assuming that “19:01: 02.034” has been designated as the timecode, the following description proceeds.

In step S413, the 3D model synchronizing unit 204 generates a first 3D model from a plurality of captured images which is obtained by the volumetric capture system 100 serving as the first image capturing system.

The 3D model synchronizing unit 204 stores, in the first table 501 of the database 103, the generated first 3D model along with the timecode being the first image capturing time designated in step S412.

For example, in the sixth row of the first table 501 illustrated in FIG. 5A, the timecode “19:01: 02.034” and the first 3D model “Data 1A226730”, which the volumetric capture system 100 generates, are stored while being associated with each other.

In step S414, the 3D model synchronizing unit 204 converts the timecode being the first image capturing time updated in step S412 into a system elapsed time being the second image capturing time.

This conversion processing converts the timecode being the first image capturing time into the form of time information which the time server 150 communicates and then converts the time information into a system elapsed time being the second image capturing time.

For example, in a case where “19:01: 02.034” is designated as the timecode being the first image capturing time, if the timecode is converted into the time form of the time server 150, in the case of the frame rate being 59.94 FPS, the time form becomes “19:01: 02.567234”. This is because, if “034”, which is the frame number of the above-mentioned timecode, is divided by 59.94 and the obtained quotient is displayed with microsecond accuracy, “0.567234” is obtained. With regard to “hour: minute: second”, it only needs to be directly used.

Next, changing from the above-mentioned time form of the time server 150 to a system elapsed time being the second image capturing time is performed with use of the start time of the second image capturing system.

Furthermore, the motion capture system 110 serving as the second image capturing system can communicate, immediately after the start of itself, the start time thereof to the volumetric capture system 100 serving as the first image capturing system. Alternatively, a configuration in which the second image capturing system preliminarily stores the start time in the database 103 and, then, the first image capturing system acquires the stored start time can be employed.

Here, as an example, the start time of the second image capturing system is assumed to be “17:30: 11.663998” (not illustrated).

In this case, “5450.903236” seconds obtained by subtracting the above-mentioned start time of the second image capturing system from the time form “19:01: 02.567234” of the time server 150 obtained by the above-mentioned conversion becomes a system elapsed time being the second image capturing time.

In this way, even in the volumetric capture system 100, which is a different image capturing system, understanding the start time of the motion capture system 110 enables acquiring a system elapsed time being the second image capturing time. In the above-mentioned example, the timecode “19:01: 02.034” of the first image capturing time has been converted into the system elapsed time “5450.903236” being the second image capturing time.

In step S415, the 3D model synchronizing unit 204 searches for the system elapsed time obtained by conversion performed in the preceding step in the second table 502 of the database 103. Referring to the example mentioned in the preceding step, the 3D model synchronizing unit 204 makes a search to determine whether a value corresponding to the system elapsed time “5450.903236” being the second image capturing time exists in the second table 502.

In a case where, as a result of the search, motion data corresponding to the system elapsed time obtained by conversion exists, the 3D model synchronizing unit 204 additionally stores, in a record of the system elapsed time, the timecode being the first image capturing time obtained before conversion performed in the preceding step. In the example mentioned here, in the second table 502, the timecode “19:01: 02.034” of the first image capturing time is then stored in the record of the system elapsed time “5450.903236” being the second image capturing time. Furthermore, processing which is performed in a case where motion data corresponding to the system elapsed time obtained by conversion does not exist is described below.

According to the above-described processing, designating a timecode being the first image capturing time enables acquiring the first 3D model and motion data required for generation of the second 3D model.

In other words, storing, in a database which one image capturing system uses, image capturing time of the other image capturing system is equivalent to performing synchronous processing for synchronously using the respective 3D models which are generated from a plurality of different image capturing systems.

In the example mentioned here, in a case where the timecode “19:01: 02.034” of the first image capturing time has been designated, the first 3D model “Data 1A226730” is acquired from the first table 501. Moreover, the second 3D model “Data 2A226830” is acquired from the second table 502.

In the first embodiment, a plurality of image capturing systems is configured to store the first image capturing time of the volumetric capture system 100, which is low in image capturing rate, in the second table of the database which the motion capture system 110, which is high in image capturing rate, uses. This is because designating image capturing time of an image capturing system which is low in image capturing rate enables using both 3D models without fail.

Furthermore, as a configuration opposite to the above-mentioned one, a configuration which stores a system elapsed time being the second image capturing time in the second table and acquires both 3D models by designating the system elapsed time can also be employed.

The above-mentioned conversion processing only needs to be performed in conformity with data which an image capturing system which is low in frame rate for image capturing generates. In conformity with which of pieces of data which respective image capturing systems generate to perform the above-mentioned conversion processing can be determined by the operator or can be determined by specifying an image capturing system which is low in frame rate.

In step S416, the 3D model synchronizing unit 204 returns the processing to step S411 and then continues the loop processing.

An example of the first subject in the volumetric capture system 100, for which the above-mentioned 3D model storage processing has been performed, and an example of the first 3D model, which is generated from that, are described with reference to FIGS. 6A and 6B.

FIG. 6A illustrates an example of the first subject of which the volumetric capture system 100 serving as the first image capturing system performs image capturing. As with FIG. 1B, FIG. 6A illustrates an example of a scene in which two persons 601 and 602 serving as the first subject who are situated in the first image capturing area 120 and are performing, for example, a musical performance or acting performance while raising their hands. In this example, the timecode is assumed to be “19:01: 02.034”. As illustrated in FIG. 6A, unlike the second subject, the first subject does not require any special equipment such as markers.

FIG. 6B illustrates examples of a first 3D model 611 and a first 3D model 612 which the 3D model generation unit 201 in the image generation apparatus 104 has generated by the method illustrated in FIG. 2A. The generated first 3D models 611 and 612 are assumed to be stored as the first 3D model “Data 1A226730” at the timecode “19:01: 02.034” in the first table 501 of the database 103.

As illustrated in FIG. 6B, in the volumetric capture system 100, a 3D model similar to the subject are able to be generated. For example, in FIG. 6A, the standing positions of the first subjects 601 and 602 are assumed to be respective points away from about 2 meters (m) from the center coordinates, such as (x, y, z)=(−2, 0, 0) and (x, y, z)=(2, 0, 0), respectively. The coordinates on a virtual space of the standing positions of the first 3D model 611 and the first 3D model 612 which the volumetric capture system 100 generates become (x, y, z)=(−2, 0, 0) and (x, y, z)=(2, 0, 0), respectively.

In FIG. 6B, in each of the first 3D model 611 and the first 3D model 612, an operation of raising his or her hand is also reflected. Not only limited to the standing position, but, in the case of using a volumetric capture technique, the shape and positional relationship of a real space are able to be directly reflected in all of the point clouds of a 3D model. Furthermore, a 3D model to be generated can be a point cloud or can be a mesh model. In the first embodiment, a 3D model is described as a point cloud.

Thus far is the description of the 3D model storage processing in the first embodiment.

### [Flowchart of Image Generation Processing]

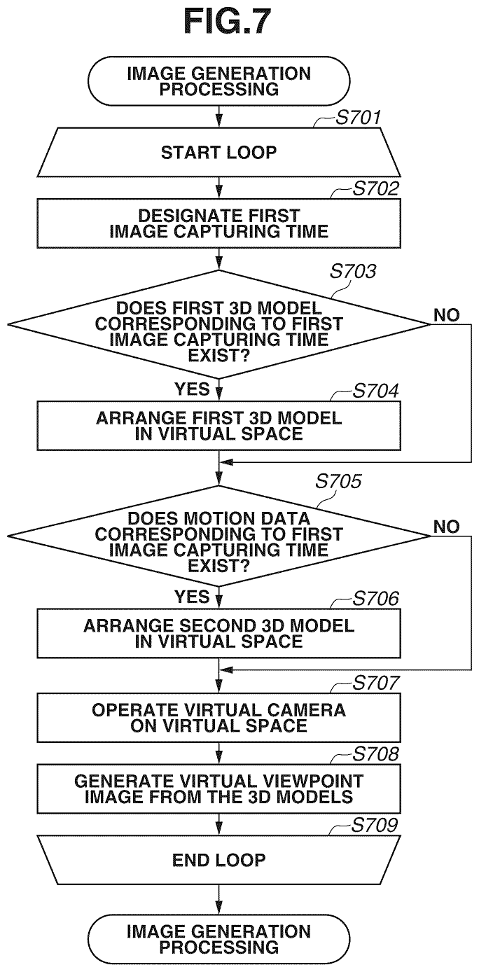

A flowchart of image generation processing in the first embodiment is described with reference to FIG. 7.

In the first embodiment, the image generation processing arranges a first 3D model, which is generated by the volumetric capture system 100, and a second 3D model which is generated by the motion capture system 110, i.e., 3D models which are generated by respective different image capturing systems, in a single virtual space and thus generates a single virtual viewpoint image.

In the image generation apparatus 104, mainly, the 3D model synchronizing unit 204 performs the image generation processing in cooperation with other functional blocks.

In step S701 to step S709, the 3D model synchronizing unit 204 repeats the image generation processing. In the first embodiment, the 3D model synchronizing unit 204 repeats the image generation processing according to the frame rate of a virtual viewpoint image to be generated. For example, in a case where the frame rate of a virtual viewpoint image is 59.94 FPS, the 3D model synchronizing unit 204 generates a virtual viewpoint image at intervals of about 16.667 milliseconds. Furthermore, with regard to an interval of one loop, in the image generation apparatus 104, the image generation processing can be implemented by setting an update rate (refresh rate) in image display on, for example, a touch panel to 59.94 FPS and performing processing in synchronization with the set update rate. Then, the image generation unit 205 acquires a timecode being image capturing time of the first image capturing system according to increment of the frame rate. Here, as an example of one frame, the timecode “19:01: 02.034” is assumed to be currently designated.

In step S702, the 3D model synchronizing unit 204 receives, via the virtual camera control unit 203, designation of a timecode being the first image capturing time. Not only limited to this, but a timecode being the first image capturing time can be designated by the virtual camera operating device 113 included in the motion capture system 110 serving as the second image capturing system, along with the position and orientation of the virtual camera 140. Alternatively, the virtual camera control unit 203 can receive, from the virtual camera operating device 113, a system elapsed time being the second image capturing time, convert the received system elapsed time into a timecode being the first image capturing time, and use the obtained timecode.

Alternatively, the 3D model synchronizing unit 204 can automatically perform increment of the timecode.

In step S703, the 3D model synchronizing unit 204 determines whether a record corresponding to the designated timecode being the first image capturing time exists in the first table 501 of the database 103. If the result of determination is true (YES in step S703), the 3D model synchronizing unit 204 advances the processing to step S704. If the result of determination is false (NO in step S703), the 3D model synchronizing unit 204 advances the processing to step S705.

In step S704, the 3D model synchronizing unit 204 reads out a first 3D model included in the record of the designated timecode from the first table 501 and arranges the read-out first 3D model in a three-dimensional virtual space. FIG. 6B is a diagram illustrating an example of the arrangement of the first 3D model obtained when the timecode “19:01: 02.034” has been designated. In FIG. 6B, the first 3D model 611 and the first 3D model 612 are arranged on a virtual space 600.

In step S705, the 3D model synchronizing unit 204 determines whether a record corresponding to the designated timecode being the first image capturing time exits in the second table 502 of the database 103. If the result of determination is true (YES in step S705), the 3D model synchronizing unit 204 advances the processing to step S706. If the result of determination is false (NO in step S705), the 3D model synchronizing unit 204 advances the processing to step S707.

In step S706, the 3D model synchronizing unit 204 reads out motion data included in the record of the designated timecode from the second table 502. Then, the 3D model synchronizing unit 204 outputs the read-out motion data to the CG processing unit 202, and acquires, from the CG processing unit 202, a second 3D model generated by associating the motion data and a preliminarily generated CG model with each other. Furthermore, in the first embodiment, FIG. 6D illustrates a second 3D model 613 obtained when the timecode “19:01: 02.034” has been designated.

Here, as a result, the 3D model synchronizing unit 204 synchronously arranges the first 3D model and the second 3D model in one virtual space 600. FIG. 6E illustrates an example of the virtual space obtained at this time. In FIG. 6E, the first 3D model 611 and first 3D model 612 and the second 3D model 613, which have been designated with the timecode “19:01: 02.034”, are arranged, while being synchronized with each other, on one virtual space 600. If the respective motions of the subject 601, subject 602, and subject 603 are aligned with each other, the motions of the respective 3D models are aligned with each other as a result.

Furthermore, the virtual space 600 is a space different from the first image capturing area 120 and the second image capturing area 130, and can be, for example, a virtual stage generated by, for example, CG.

In step S707, the 3D model synchronizing unit 204 receives, for example, a user operation via the virtual camera control unit 203, rotates and moves the virtual camera 140 on a three-dimensional virtual space according to the received input, and thus determines the position and orientation of the virtual camera 140.

In step S708, the 3D model synchronizing unit 204 projects, onto the virtual camera 140, the first 3D model and second 3D model arranged in the virtual space, thus generating a virtual viewpoint image. FIG. 6F illustrates an example of the virtual viewpoint image generated at this time.

FIG. 6F illustrates an example of a virtual viewpoint image obtained by projecting, onto the virtual camera 140 set in step S707, the first 3D model 611, first 3D model 612, and second 3D model 613 for the timecode “19:01: 02.034”. As with the respective 3D models explained with reference to FIG. 6E, even in the virtual viewpoint image, a scene in which the respective subjects are performing, for example, a musical performance or acting performance while raising their hands and motions of the respective subjects are aligned with each other is obtained.

In step S709, the 3D model synchronizing unit 204 performs, for example, increment of the timecode, returns the processing to step S701, and then continues the loop processing in units of frame. Furthermore, while, here, for the sake of explanation, the timecode “19:01: 02.034” is taken as an example, similar processing can be performed as long as the timecode indicates image capturing times which are stored in the first table 501 and second table 502 of the database 103. Moreover, naturally, it is also possible to process the timecode in a serial manner and generate a virtual viewpoint image as a moving image.

According to the above-described processing, in a configuration which performs image capturing of subjects in respective different spaces with use of different image capturing systems for, for example, volumetric capture and motion capture, it is possible to generate respective 3D models synchronized with each other from the respective pieces of captured data and thus generate a single virtual viewpoint image.

Furthermore, in the first embodiment, a case example in which, by performing conversion processing on the first image capturing time of the first 3D model, motion data for the second image capturing time corresponding to the first image capturing time exists has been described. However, there may be a case where, since the frame rate in the plurality of first sensor systems 101 and the frame rate in the plurality of second sensor systems 111 are different from each other, even at the time of performing conversion processing, a record of the second image capturing time corresponding to the first image capturing time does not exist in the second table 502.

In that case, with use of motion data for the current system elapsed time and motion data obtained before that time, motion data between the above-mentioned two pieces of motion data can be acquired by interpolation processing.

Specifically, if, in step S415 illustrated in FIG. 4B, it is determined that motion data corresponding to the second image capturing time obtained by converting the first image capturing time does not exist in the second table 502, the 3D model synchronizing unit 204 performs interpolation processing. The 3D model synchronizing unit 204 performs interpolation for motion data with use of, among second image capturing times existing in the second table 502, pieces of motion data corresponding to second image capturing times before and after the second image capturing time determined not to exist. With regard to the interpolation processing, the 3D model synchronizing unit 204 performs linear interpolation on the coordinates of respective regions included in the pieces of motion data corresponding to second image capturing times before and after the second image capturing time determined not to exist, and thus performs interpolation for motion data corresponding to the second image capturing time determined not to exist. Furthermore, the 3D model synchronizing unit 204 can perform not linear interpolation but, for example, Lagrange interpolation.

According to the above-described processing, even in a case where data corresponding to the same time information does not exist, it is possible to generate a virtual viewpoint image with use of pieces of data generated from respective different systems.

Furthermore, while, in the above description, in a case where, in step S415, it is determined that motion data corresponding to the second image capturing time obtained by converting the first image capturing time does not exist in the second table 502, the 3D model synchronizing unit 204 performs interpolation processing, the first embodiment is not limited to this. For example, in a case where, in step S705, as a result of determining whether motion data corresponding to the first image capturing time exits, the result of determination is no, the 3D model synchronizing unit 204 can perform the above-mentioned interpolation processing.

### Second Embodiment

In a second embodiment, an example in which a generation time of the first 3D model and a generation time of the second 3D model are different from each other is described. Specifically, an example in which the generation time of the first 3D model in the volumetric capture system 100 is longer than a time required for generating motion data in the motion capture system 110 and performing processing for associating the motion data and a CG model with each other is described.

Furthermore, the time required for generating motion data and performing processing for associating the motion data and a CG model with each other is, in other words, the generation time of the second 3D model. If there is not a method described in the second embodiment, the generation of one 3D model will not be in time and, thus, it is impossible to synchronously arrange both 3D models in a virtual space. Therefore, there may be a case where an unnatural virtual viewpoint image in which one subject does not exist or a plurality of 3D models unsynchronized in time is shown is generated.

In the second embodiment, the same configuration as that in the first embodiment, which performs image capturing of respective different spaces by a plurality of image capturing systems, is used to generate one 3D model in first and cause the operator to operate a virtual camera while confirming displaying of the one 3D model. Specifically, the configuration generates a second 3D model in the motion capture system 110 in first and, while displaying a virtual viewpoint image of the second 3D model, causes the operator to operate the virtual camera. Then, the configuration generates a first 3D model in the volumetric capture system 100 with use of viewpoint information about the virtual camera. After that, the configuration synchronously arranges both 3D models in a virtual space, thus generating a virtual viewpoint image.

In the second embodiment, the image processing system 160 and the image generation apparatus 104 in the first embodiment are directly used, and the configurations thereof are omitted from description here. In the second embodiment, as mentioned above, the motion data storage processing illustrated in FIG. 4A, the second table 502 illustrated in FIG. 5C, and the 3D model storage processing illustrated in FIG. 4B are partially different from those in the first embodiment.

In the first embodiment, the motion data storage processing is processing which the second sensor recording apparatus 112 in the motion capture system 110 performs to store motion data acquired by the motion capture system 110 in the second table 502 of the database 103. In addition to that, in the second embodiment, the motion data storage processing becomes processing for also storing viewpoint information about the virtual camera, along with the motion data, in the second table 502.

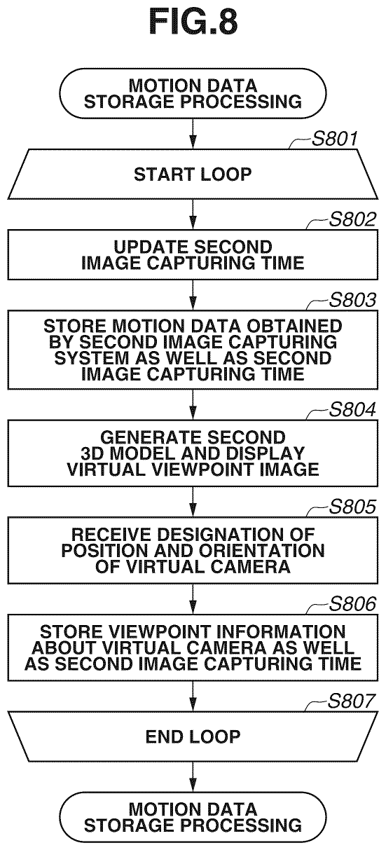

FIG. 8 is a flowchart illustrating storage processing for motion data according to the second embodiment.

In step S801 to step S807, the second sensor recording apparatus 112 repeats the motion data storage processing as loop processing. Thus, the second sensor recording apparatus 112 repeats the present loop processing according to an image capturing frame rate of the motion capture system 110. For example, in a case where the image capturing frame rate is 240 FPS, the second sensor recording apparatus 112 repeats the present loop processing at intervals of about 4.16 milliseconds.

In step S802, the second sensor recording apparatus 112 updates the system elapsed time, which is the second image capturing time. For example, the system elapsed time is incremented according to the image capturing rate. Furthermore, the system elapsed time can be connected to the time server 150 via, for example, Network Time Protocol (NTP) and thus be updated as needed.

In step S803, the second sensor recording apparatus 112 stores, in the second table 502 of the database 103, motion data acquired from the motion capture system 110 along with the current system elapsed time being the second image capturing time. For example, in the fifth row of the second table 502, motion data “Data 2A226830” is currently stored in a record of the system elapsed time “5450.903236”. In the example mentioned here, the behavior of the second subject is the same as that of the subject 603 illustrated in FIG. 6C.

In step S804, the second sensor recording apparatus 112 uses the motion data acquired in the preceding step to generate a second 3D model. An example of the second 3D model generated here is the same as the second 3D model 613 illustrated in FIG. 6D. Moreover, the second sensor recording apparatus 112 projects the second 3D model onto the virtual camera the position and orientation of which have been designated in step S805 in the preceding loop processing and displays a virtual viewpoint image on which only the second 3D model has been projected. FIG. 6G illustrates an example of the virtual viewpoint image displayed at this time. As illustrated in FIG. 6G, the virtual viewpoint image displayed here is a virtual viewpoint image on which only the second 3D model 613 has been projected. Furthermore, in a case where the current loop processing is loop processing performed for the first time, the position and orientation of the virtual camera take initial values.

In step S805, the second sensor recording apparatus 112 receives an operation performed on the virtual camera. The operator of the virtual camera performs an operation on the virtual camera while confirming the virtual viewpoint image displayed in the preceding step. While, as illustrated in FIG. 6G, at that time, only the second 3D model is projected on the virtual viewpoint image, since the operator generally understands the size of the stage in the virtual space 600, the operator is able to sufficiently operate the virtual camera even with such a virtual viewpoint image.

Moreover, similarly, in a case where the subject is, for example, an artist who is performing a musical performance of acting performance, since, unlike sports, a rough motion of the subject or the range thereof is preliminarily understood, the operator is able to sufficiently operate the virtual camera even with such a virtual viewpoint image.

In step S806, the second sensor recording apparatus 112 stores, as viewpoint information, the position and orientation of the virtual camera designated in step S805 in the second table 502 of the database 103.

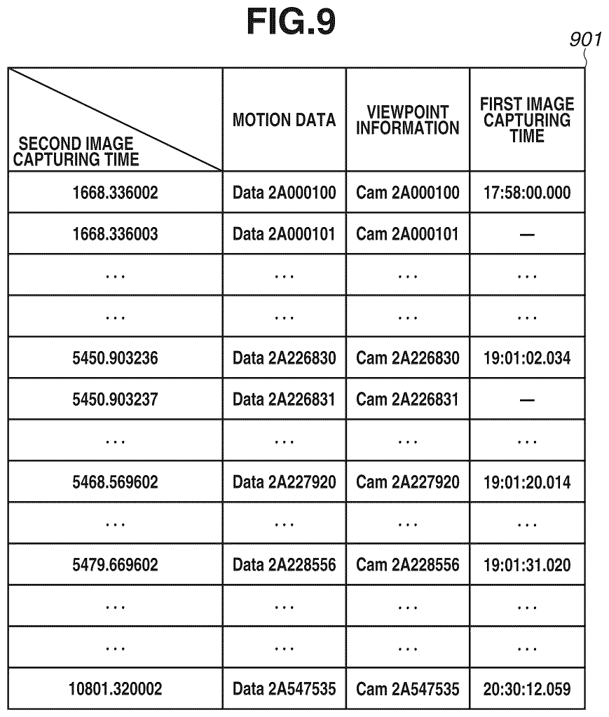

FIG. 9 illustrates a second table 901 of the database 103 which is generated in the second embodiment. With regard to the second table 901, for example, in a record in the fifth row of the second table 901, viewpoint information “Cam 2A226830” is stored for the system elapsed time “5450.903236”.

In step S807, the second sensor recording apparatus 112 returns the processing to step S801 and then repeats the above-described motion data storage processing.

Thus far is the description of the motion data storage processing in the second embodiment.

Next, 3D model storage processing in the second embodiment is described. The 3D model storage processing is, as described in the first embodiment, processing which, mainly, the volumetric capture system 100 serving as the first image capturing system performs to generate and store a first 3D model.

The 3D model storage processing in the second embodiment differs only in step S413 from the 3D model storage processing in the first embodiment illustrated in FIG. 4B. Such a difference is described as follows.

In the above-described first embodiment, in step S413, the 3D model synchronizing unit 204 generates a first 3D model from a plurality of captured images obtained by the volumetric capture system 100 with use of a shape estimation method described with reference to FIG. 2A.

The second embodiment differs from the first embodiment in that, with respect to color application processing to a point cloud generated by shape estimation, the 3D model synchronizing unit 204 uses the viewpoint information stored in the second table 502 in step S806.

Specifically, based on the position and orientation of the virtual camera 140 designated by the viewpoint information, the 3D model synchronizing unit 204 selects at least one camera close to such position and orientation from the plurality of first sensor systems 101 and then performs color application processing to a point cloud with use of a captured image obtained by the selected camera. Performing this processing causes an appearance viewed from the virtual camera 140 to come closer to an actual captured image and thus enables increasing the image quality.

On the other hand, generation processing for the first 3D model in step S413 becomes longer in processing time than that in the first embodiment.

Therefore, in the second embodiment, the 3D model synchronizing unit 204 changes, in addition to a part of the 3D model storage processing described above, a part of the image generation processing (FIG. 7) in the first embodiment, and uses the changed image generation processing.

Next, image generation processing in the second embodiment is described. The image generation processing in the above-described first embodiment is processing for, mainly, based on the designated first image capturing time, arranging the first 3D model and second 3D model in a virtual space and thus generating a virtual viewpoint image.

The image generation processing in the second embodiment differs in step S702 from the image generation processing in the first embodiment illustrated in FIG. 7, and such difference is described as follows.

In the above-described first embodiment, in step S702, the 3D model synchronizing unit 204 receives designation of a timecode for the first image capturing time via the virtual camera control unit 203.

In the second embodiment, the virtual camera control unit 203 delays the received timecode for the first image capturing time by a generation processing time of the first 3D model and uses the delayed timecode. In a case where the virtual camera control unit 203 does not delay the timecode, an issue occurs in which, in the timecode designated in the virtual camera control unit 203, the first 3D model becomes under generation processing and thus becomes unable to be acquired from the database 103. Furthermore, a time required for generation processing for the first 3D model is assumed to be preliminarily known.

For example, in a case where 10 seconds is required for the above-mentioned generation processing for the first 3D model (in step S413), the virtual camera control unit 203 performs addition of 11 seconds with the inclusion of a margin and, in step S702, sets the timecode with 11 seconds added thereto. Processing operations in step S703 and subsequent steps only need to be continued as with the first embodiment.

Since, by adding the above-mentioned delay time, a first 3D model which has been already completely generated exists in the first table 501 of the database 103, it is possible to arrange the first 3D model in the virtual space 600 in steps S703 and S704 mentioned in the first embodiment.

Moreover, in steps S705 and S706 in the first embodiment, in the timecode with the delay time added thereto, it is possible to arrange the second 3D model in the virtual space 600.

In this way, since the first 3D model and the second 3D model are 3D models corresponding to the timecodes with the same delay time added thereto, it is possible to synchronously arrange the first 3D model and second 3D mode in a virtual space as with the first embodiment. Moreover, the same also applies to a virtual viewpoint image generated from these 3D models.

Thus far is the description of the image generation processing in the second embodiment.

According to the second embodiment, even in a case where processing times for 3D models which are generated by respective different systems differ from each other, it is possible to synchronously generate 3D models from the respective pieces of captured image data and generate a single virtual viewpoint image.

### OTHER EMBODIMENTS

The present disclosure can also be implemented by processing for supplying a program for implementing one or more functions of the above-described embodiments to a system or apparatus via a network or a storage medium and causing one or more processors in a computer of the system or apparatus to read out and execute the program. Moreover, the present disclosure can also be implemented by a circuit (for example, an application specific integrated circuit (ASIC)) which implements one or more functions of the above-described embodiments.

The present disclosure is not limited to the above-described embodiments, but can be altered or modified in various manners without departing from the spirit and scope of the present disclosure. Accordingly, claims are accompanied to disclose the scope of the present disclosure.

According to an aspect of the present disclosure, it is possible to generate a virtual viewpoint image with use of pieces of data which are generated by respective different systems and are managed under respective different criteria.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205449 filed Nov. 26, 2024, which is hereby incorporated by reference herein in its entirety.

What is claimed is:

1. An image processing system comprising:
one or more memories storing instructions; and
one or more processors executing the instructions to:
record, while associating with each other, a three-dimensional (3D) model of a first subject generated with use of a plurality of captured images acquired by image capturing performed by a plurality of image capturing apparatuses and first time information;
record, while associating with each other, second time information which is measured under a criterion different from that for the first time information and posture information indicating a posture of a second subject generated with use of a plurality of captured images acquired by image capturing performed by a plurality of image capturing apparatuses;
convert the first time information to identify the second time information corresponding to the first time information; and
generate a virtual viewpoint image based on the 3D model corresponding to the first time information and the posture information corresponding to the identified second time information.

2. The image processing system according to claim 1, wherein the second time information is information indicating time which is counted at a frame rate different from that for the first time information.

3. The image processing system according to claim 2, wherein the second time information is information indicating time which is counted at a frame rate higher than that for the first time information.

4. The image processing system according to claim 1, wherein the second time information is information indicating time which is counted in a unit different from that for the first time information.

5. The image processing system according to claim 1,
wherein the one or more processors executes the instructions further to, in a case where the second time information corresponding to the first time information is not currently recorded, make an interpolation for the posture information corresponding to the second time information based on pieces of time information measured before and after the second time information, and
wherein the virtual viewpoint image is generated based on the 3D model corresponding to the first time information and the posture information subjected to the interpolation.

6. The image processing system according to claim 1, wherein the virtual viewpoint image is generated based on the 3D model corresponding to the first time information and a preliminarily generated 3D model associated with the posture information corresponding to the identified second time information and different from the 3D model corresponding to the first time information.

7. The image processing system according to claim 1, wherein the posture information is information indicating positions of respective regions of the second subject.

8. The image processing system according to claim 1, wherein the image processing system includes a system for volumetric capture.

9. The image processing system according to claim 1, wherein the image processing system includes a system for motion capture.

10. An image processing method comprising:
recording, while associating with each other, a three-dimensional (3D) model of a first subject generated with use of a plurality of captured images acquired by image capturing performed by a plurality of image capturing apparatuses and first time information;
recording, while associating with each other, second time information which is measured under a criterion different from that for the first time information and posture information indicating a posture of a second subject generated with use of a plurality of captured images acquired by image capturing performed by a plurality of image capturing apparatuses;
converting the first time information to identify the second time information corresponding to the first time information; and
generating a virtual viewpoint image based on the 3D model corresponding to the first time information and the posture information corresponding to the identified second time information.

11. A non-transitory computer-readable storage medium storing a program for causing a computer to execute an image processing method comprising:
recording, while associating with each other, a three-dimensional (3D) model of a first subject generated with use of a plurality of captured images acquired by image capturing performed by a plurality of image capturing apparatuses and first time information;
recording, while associating with each other, second time information which is measured under a criterion different from that for the first time information and posture information indicating a posture of a second subject generated with use of a plurality of captured images acquired by image capturing performed by a plurality of image capturing apparatuses;
converting the first time information to identify the second time information corresponding to the first time information; and
generating a virtual viewpoint image based on the 3D model corresponding to the first time information and the posture information corresponding to the identified second time information.
